(19) United States
(12) Patent Application Publication
(10) Pub. No.: US 2017/0113423 A1
(43) Pub. Date: Apr. 27, 2017

(54) Composite Railroad Tie and Method of Manufacturing Same

(71) Applicant: Strongwell Corporation, Bristol, VA (US)

(72) Inventors: Joshua Lynn McCroskey, Bluff City, TN (US); Brian Christopher Lancaster, Bristol, TN (US); Bill Joe Harlow, Bristol, TN (US); David Edward Gibbs, Bristol, VA (US)

(21) Appl. No.: 14/918,825

(22) Filed: Oct. 21, 2015

(51) Int. Cl. B29C 70/52; B29C 70/06; B29C 47/12; C08J 9/18

(52) U.S. Cl. CPC B29C 70/526; C08J 9/18; B29C 70/06; B29C 47/12; C08J 2300/24; B29K 2105/253

(57) ABSTRACT

Lightweight composite structural articles having a shell and core comprising a specially-formulated resin, and methods of manufacturing the same. In particular embodiments, the present invention relates to a composite railroad tie comprising an outer fiber-reinforced polymer shell and a unique core formed from a thermoexpandable resin mixture with microcapsules, which railroad tie is manufactured by extruding or pultruding the shell and core through a specially adapted die having a graded cavity, allowing for controlled expansion of the core as the shell and core are passed through the die.

### BACKGROUND OF THE INVENTION

Field of the Invention

The present invention relates to lightweight but dense structural articles having a shell and core comprising a specially-formulated resin, and methods of manufacture of the same. In particular embodiments, the present invention relates to a composite railroad tie comprising an outer fiber-reinforced polymer shell, that can be open-shaped in the machine direction of the tie, and a unique core formed from an expandable resin mixture, which railroad tie is manufactured by extruding or pultruding the shell and core through a specially adapted die having a graded cavity, allowing for controlled expansion of the core as the shell and core are pultruded (or extruded) through the die.

Description of the Related Art

Composites of polymers are an alternative to traditional materials such as wood, steel, and concrete because they provide comparable strengths at a lighter weight and may be made with recyclable material. Wood railroad ties are relatively heavier and particularly susceptible to environmental degradation and exponential weakening over time.

It is known to make railroad ties from thermoplastic materials, for example, as described in U.S. Pat. No. 5,799,870 to John C. Bayer. It is known to make railroad ties from sand and recycled thermoplastic containers, for example, as described in U.S. Pat. No. 5,055,350 to Charles W. Neefe. It is known that railroad ties may be made from recycled tire fragments, for example, as described in U.S. Pat. No. 5,238,734. It is known that railroad ties may be made from combinations of polymeric components combined with rubbery polymeric component obtained from disposed tires, such as described in U.S. Pat. No. 5,886,078 to Henry W. Sullivan et al. It is known to make porous flexible pipes from thermoplastic materials and thermoset materials, for example, as described in U.S. Pat. No. 5,366,365 to Henry W. Sullivan et al. Methods of pultrusion generally have been disclosed in the prior art, such as in U.S. Pat. No. 5,556,496 to Joseph E. Sumerak. Composite resin-based materials have been disclosed in the prior art, such as in U.S. Patent Application Nos. 2002/0025423 A1 and 2015/0174791 A1.

However, the prior art taken individually and in combination fails to teach a reliable, lightweight, sturdy polymer railroad tie, or a manufacturing process for making such a tie.

A substitute for wood was also disclosed in U.S. Pat. No. 8,324,420 to Richard W. Roberts, Jr. (see also related U.S. Application No. 2015/0064379), specifically an enclosed tubular shell was filled with a foam core comprised of polyolefin beads which expand and fill the cavity.

The present invention is a significant improvement over U.S. Pat. No. 8,324,420, in that the inventive products can be made to be similar in weight to the product described in U.S. Pat. No. 8,324,420, yet with a core that may be seven times more dense than that disclosed in U.S. Pat. No. 8,324,420 (see U.S. Pat. No. 8,324,420 at Table I at col. 6, ll. 35-58), meaning the claimed invention is stronger and more conveniently fastened when used in a railroad track application than the prior art.

The difference in density is due to the unique composition of the core resin formula disclosed by the present invention along with the manufacturing process and specially-adapted die for forming the product. For example, U.S. Pat. No. 8,324,420 teaches a core composition using heat expandable polyolefin beads, which results in the so-called “foam core” having a lower density in the middle of the structure than the “foam” at its two ends. On the other hand, the core of the current invention uses, for example, a polymer shell encapsulating a gas blowing agent, or microcapsules. Such expandable microcapsules as used in the core resin create a significantly denser core (when compared to the “foam” core disclosed by U.S. Pat. No. 8,324,420), which allows for insertion of a fastener, such as a nail or screw, that will sufficiently hold the nail or screw in place to adequately fasten, for example, a railroad tie to a railroad track, and without affecting the structural integrity of the overall structure. The “foam” core disclosed by U.S. Pat. No. 8,324,420 is not dense enough to adequately hold a typical railroad-industry nail or screw in place, which is why the use of a ring spike to fasten the tie (see, e.g., FIG. 7 of U.S. Pat. No. 8,324,420) is required, which is not a preferred way of attaching railroad ties. Moreover, based on the continuous manufacturing process claimed herein (e.g., pultrusion or extrusion), the resin-based core of the presently disclosed structure has a constant density from the middle to the end of, for example, a railroad tie.

Additionally, typically the bond achieved between a plastic shell and a foam core during a process in which the two are formed independently, such as in U.S. Pat. No. 8,324,420, is relatively poor, leaving the product structurally less sound than the disclosed invention herein. Moreover, the polyolefin beads disclosed in U.S. Pat. No. 8,324,420 are less advantageous in both terms of overall bond strength and structural integrity compared to the novel core resin as described and claimed herein. For example, the core foam of U.S. Pat. No. 8,324,420 is shown to experience so-called “deflection,” or deformation according to Table 1 in column 6. The core material disclosed herein differs from the foam in U.S. Pat. No. 8,324,420 in that the core material disclosed herein typically has “memory;” once the core material herein is bent and the load is released it will return to its original configuration. In fact, the core of the present invention is not like a foam at all, but rather a denser yet surprisingly light plastic.

Furthermore, U.S. Pat. No. 8,324,420 requires a fully enclosed shell, wherein the present invention includes open-sided structures (wherein the interior core resin is exposed on one elongated side in the machine direction and on both ends, or on both ends of a tubular structure). A composite structure wherein the interior core resin is exposed on one or more elongated sides in the machine direction, for example when used as a railroad tie, is capable of more soundly engaging gravel on which it will be laid, while also using less material and allowing for more efficient manufacturing. U.S. Pat. No. 8,324,420 discloses several steps, including blow-molding of a plastic shell, then filling the shell with the polyolefin beads, and releasing excess gas due to steam injection in order to normalize the pressure within the shell to the atmospheric pressure outside the shell. However, the present invention teaches using a pultrusion or extrusion process, which continuously creates the shell and the core as the core resin is added to the cavity of the shell, resulting in a more efficient manufacturing process. One of skill in the art will understand that a continuous process such as the one disclosed herein will result in a much faster processing time to make a final railroad tie. Further, the shell and core resins may be cured at the same time, creating an intermingling of the two and yielding a more substantial bond between shell and core.

Additionally, the polypropylene beads claimed by U.S. Pat. No. 8,324,420 are thermoplastic. At high outdoor temperatures, such as those railroad ties are exposed to, polypropylene beads are known to lose structural integrity (e.g., they soften), whereas thermoset resins, such as those disclosed in the present invention, maintain a higher percentage of structural integrity at higher temperatures compared to thermoplastic.

While pultrusion has become recognized in the art as a method available for manufacturing fiber-reinforced polymer engineered composite materials, processes for producing pultruded thermoset articles have been generally limited to the production of products having a constant cross-section as the article is created by passing through a pultrusion die. The manufacturing process disclosed by the present invention differs from the prior art because, among other things, it provides for a specially adapted die that includes a sloped gradient in the interior cavity of the die whereby the thermoexpandable material of the core is allowed to rise in a controlled manner over time as it continues to pass through the die. A preferred embodiment would allow for the interior of the die to increase in volume over the length of the die, whereby an inlet disposed at a proximal end of a housing is configured to provide for a first smaller cross-sectional area at the proximal end of the housing and a second larger cross-sectional area at the distal end of the housing. Between the proximal and distal ends of the housing, a shaping cavity in communication with the inlet and terminating at a distal end of the housing at an outlet is used to control the shape and forming of the core resin as it rises inside the die.

Attempts to make a railroad tie from materials other than or in addition to wood include: U.S. Pat. No. 7,714,056 of Henry W. Sullivan et al., U.S. Pat. No. 7,950,592 to Qiang Yuan, U.S. Patent Application US 2015/0028121 to Miguel Rodriguez Plaza et al., U.S. Patent Application US 2013/0082116 to Eric Perraud et al., U.S. Pat. No. 7,331,533 to John C. Bayer et al., U.S. Patent Application US 2014/0263683 to Jagadeesh Krishnan et al., U.S. Pat. No. 6,021,958 to Douglas L. Smith, U.S. Pat. No. 7,802,736 to Michael A. N. Scobie, U.S. Pat. No. 7,942,342 to Scott Powers et al., U.S. Pat. No. 7,866,569 to Charles E. Cadwell, U.S. Pat. No. 7,314,182 to Michael R. Little et al., U.S. Pat. No. 7,592,059 to Kevin K. Lane et al., U.S. Patent Application US 2011/0021123 to Mary Jo Kulp et al., U.S. Pat. No. 6,247,651 to John Marinelli, U.S. Pat. No. 6,336,265 to Siegfried Niedermair, U.S. Pat. No. 6,179,215 to Marc Shea, and U.S. Pat. No. 6,191,228 to Thomas Nosker et al.

### SUMMARY OF THE INVENTION

The present invention provides a composite structural article and method of manufacture of a composite structural article. The composite structural article comprises a fiber-reinforced polymer (“FRP”) shell and a thermosetting resin core including heat expandable microcapsules. The core according to embodiments can comprise thermosetting resin, a catalyst matrix, reinforcement materials, and expandable microcapsules, such as an expandable microcapsule comprising a polymer shell encapsulating a gas blowing agent. In preferred embodiments, the FRP shell is an open-shaped structure, for example, wherein one side of the structure is open in the machine direction so that the core is exposed. Alternatively, the FRP shell is tubular wherein both ends of the tubular structure are open so that the core is exposed. The composite structural article with the FRP shell and core may be used as, for example, a railroad tie.

In embodiments, the composite structural article is prepared using a pultrusion process whereby the FRP shell and core are made in a continuous fashion. As the FRP shell enters the die, the core resin is added to the shell, and the shell and core are cured at the same time. In a preferred embodiment, the die is specially adapted so that the interior of the die increases in volume from an entrance of the die to an exit. As the core moves through the interior of the die from the entrance to the exit, heat expands the thermosetting resin of the core, and the interior shape of the die thereby is capable of controlling and limiting the expansion of the core to a desired configuration. In such a manner, a cross-section of the core viewed at one point in the die would differ from a cross-section of the core viewed at a later point in the same die. This preferred simultaneous curing process may also be controlled in such a manner that the FRP shell and the core partially fuse, thereby increasing the bond between the FRP shell and the core.

In accordance with one embodiment of the present invention, a railroad tie is provided comprising: (1) an FRP shell and (2) a core of thermosetting resin, a catalyst matrix, reinforcement materials, and expandable microcapsules, such as an expandable microcapsule comprising a polymer shell encapsulating a gas blowing agent. Preferably, the railroad ties are formed by combining the FRP shell and the raw materials of the core (e.g., thermosetting resin, a catalyst matrix, reinforcement materials, and expandable microcapsules) in the die, then curing the components into a composite railroad tie. Most preferred railroad ties comprise an FRP shell that is open-ended on one side in the machine direction and on the two ends of the tie.

In accordance with another embodiment of the present invention, the core composition comprises about 50 to 90 weight percent total of thermosetting resin, from about 0.2 to 10 of weight percent total of catalyst matrix, from about 15 to 50 weight percent total of reinforcement material, and from about 0.5 to 30 weight percent total of microcapsules. In a preferred embodiment, the core resin composition comprises around 73 weight percent total of thermosetting resin, around 0.33 weight percent total of catalyst matrix, around 24 weight percent total of reinforcement material, and around 2 weight percent total of microcapsules. In another preferred embodiment, the core resin composition comprises around 72.85 weight percent total of thermosetting resin, around 0.417 weight percent total of catalyst matrix, around 28.62 weight percent total of reinforcement material, and around 2.43 weight percent total of microcapsules. In another preferred embodiment, the core resin composition comprises around 68.68 weight percent total of thermosetting resin, around 0.442 weight percent total of catalyst matrix, around 24.28 weight percent total of reinforcement material, and around 2.29 weight percent total of microcapsules.

This composition as well as others using the disclosed components of the core resin result in a light but surprisingly dense core composition, which allows the overall structural article to be used as, for example, a railroad tie, since preferred means of fastening railroad ties like spikes and screw spikes may be used. This is in contrast to other resin-based railroad ties in the prior art, which contain core material having insufficient density for adequate fastening using typical railroad spikes. Other resin-based ties also suffer from insufficient structural integrity to withstand insertion of a typical railroad spike or provide for the kind of strength necessary for railroad ties, which are constantly subjected to environmental influences and physical abuse inherent in the railroad industry.

In accordance with another embodiment of the present invention, a die is provided wherein the interior or cavity of the die increases in volume in the machine direction from one earlier point in the die to a later point in the same die, such that the heat expandable core of the structural article may expand over time in a controlled manner. Unlike other pultrusion or extrusion dies, this unique graded die interior allows the manufacturer to control, for example, the density of the pultruded or extruded material. It would also allow the manufacturer to control other factors, such as rate of expansion.

Specific aspects of the invention include Aspect 1, which is a method of manufacturing a composite structural form, the method comprising: providing a shell comprising a first resin composition, disposing a second resin composition in a cavity of the shell to provide a core, and passing the shell and the core through a die to prepare a composite structural form. Passing is a term understood by one of skill in the art and generally means moving through, progressing, travelling, translating, etc., from one point in the die to another point in the die. Preferably, the first resin composition and the second resin composition are pultruded through a die to prepare a composite structural form, although the first resin composition and the second resin composition can be extruded through a die to prepare a composite structural form. In the most preferred aspect, the first resin composition and the second resin composition are continuously passed through a die to prepare a composite structural form.

Aspect 2 is a shell used in the method of Aspect 1, wherein the cavity of the shell is defined by an elongated opening. Alternatively, the shell may be a tubular structure with the second resin exposed at the ends of the tubular structure, or the ends may be capped, such as the ends of the tubular structure comprising the first resin composition.

Aspect 3 is a shell of Aspect 2, wherein the shell is disposed in the die with the elongated opening oriented in a direction capable of receiving the second resin during the passing of the shell through the die.

Aspect 4 is a shell of any of Aspects 2-3, wherein the shell has a length and a width, and the elongated opening of the shell has a length equal to the length of the shell and a width of 75% up to 100% of the width of the shell.

Aspect 5 is a shell of any of Aspects 2-4, wherein the shell is three-sided and provides an elongated opening in the shell.

Aspect 6 is a method of any of Aspects 2-5, wherein the shell comprises a reinforced resin composition.

Aspect 7 is a method of Aspect 1, optionally employing the shell of any of Aspects 2-6, wherein the second resin composition is allowed to fuse with the first resin composition as the first and second resin compositions are subjected at the same time to conditions capable of curing the first and second resin compositions.

Aspect 8 is a method of Aspect 1, optionally employing the shell of any of Aspects 2-7, wherein the second resin composition has a density that is less than a density of the first resin composition.

Aspect 9 is a method of Aspect 1, optionally employing the shell of any of Aspects 2-8, wherein the first resin composition and the second resin composition are subjected at the same time to conditions capable of curing the first and second resin compositions.

Aspect 10 is a method of Aspect 1, optionally employing the shell of any of Aspects 2-9, wherein the first resin composition is cured by heat.

Aspect 11 is a method of Aspect 1, optionally employing the shell of any of Aspects 2-10, wherein the second resin composition is cured by heat.

Aspect 12 is a method of Aspect 1, optionally employing the shell of any of Aspects 2-11, wherein the first resin composition, the second resin composition, or both are preheated before entering the die.

Aspect 13 is a method of Aspect 1, optionally employing the shell of any of Aspects 2-12, wherein a radio frequency wave generator is used to preheat the first resin composition, the second resin composition, or both.

Aspect 14 is a composite structure comprising a shell comprising a first resin composition, and a core having a second resin composition comprising thermosetting resin, a catalyst matrix, reinforcement materials, and expandable microcapsules.

Aspect 15 is an article of Aspect 14, wherein the composite structure is formed by pultruding the shell and core, preferably through a die.

Aspect 16 is an article of Aspect 14, wherein the composite structure is formed by extruding the shell and core, preferably through a die.

Aspect 17 is an article of any of Aspects 14-16, wherein the second resin composition has a density that is less than a density of the first resin composition.

Aspect 18 is an article of any of Aspects 14-17, wherein the shell comprises one or more reinforcement materials.

Aspect 19 is an article of any of Aspects 14-18, wherein the shell comprises one or more reinforcement materials chosen from fiberglass, fiberglass-based material, wood-based materials, or recycled fiber-reinforced polymer.

Aspect 20 is an article of any of Aspects 14-19, wherein the second resin composition has a density that allows for a fastener to be inserted into the second resin composition and adequately retained, and without significantly affecting the mechanical properties of the article.

Aspect 21 is an article of any of Aspects 14-20, wherein the shell provides an elongated opening in the shell. Alternatively, the shell may be a tubular structure with the second resin exposed at the ends of the tubular structure, or the ends may be capped, for example, comprising the first resin composition.

Aspect 22 is an article of any of Aspects 14-21, wherein the shell is three-sided and provides an elongated opening in the shell.

Aspect 23 is an article of any of Aspects 14-22, wherein the article is a railroad tie.

Aspect 24 is an article of any of Aspects 14-23, wherein the article is a railroad tie and contains holes for securing said railroad tie to a support, such as a railroad track.

Aspect 25 is an article of any of Aspects 14-24, wherein the sides of the shell are concave, or the sides of the shell are convex, or one side is concave and one side is convex.

Aspect 26 is an article of any of Aspects 14-25, wherein the shell comprises a base and two side walls and the two side walls are parallel to one another or are disposed at an angle relative to the base in the range of between 0-180 degrees, such as at an angle from between 10-170 degrees, or 20-150 degrees, or 45-120 degrees, or 60-100 degrees, or 80-95 degrees, or 90 degrees.

Aspect 27 is an article of any of Aspects 14-26, wherein the shell comprises a base and only two side walls, wherein the two side walls are parallel to one another and wherein each side wall is disposed perpendicular to the base.

Aspect 28 is a resin composition comprising a thermosetting resin, a catalyst matrix, reinforcement materials, and expandable microcapsules.

Aspect 29 is a resin composition of Aspect 28, wherein the thermosetting resin is chosen from one or more of polyester resin, vinyl ester resin, epoxy resin, phenolic resin, acrylic resin, or urethane resin.

Aspect 30 is a resin composition of any of Aspects 28-29, wherein the reinforcement materials are chosen from one or more of fiberglass-based materials, wood-based materials, or recycled fiber-reinforced polymer.

Aspect 31 is a resin composition of any of Aspects 28-30, wherein the thermosetting resin is chosen from one or more of polyester resin, vinyl ester resin, epoxy resin, phenolic resin, acrylic resin, or urethane resin and wherein the reinforcement materials are chosen from one or more of fiberglass-based materials, wood-based materials, or recycled fiber-reinforced polymer.

Aspect 32 is a resin composition of any of Aspects 28-31, wherein the expandable microcapsules are thermally expandable microcapsules comprising a polymer shell encapsulating a gas blowing agent.

Aspect 33 is a resin composition of any of Aspects 28-32, wherein the thermosetting resin is provided as a liquid resin mixture comprising resin, one or more additives chosen from catalysts, accelerators, reinforcement materials, and expandable microcapsules.

Aspect 34 is a resin composition of any of Aspects 28-33, wherein the catalyst matrix comprises one or more latent catalysts.

Aspect 35 is a resin composition of Aspects 33 or 34, wherein the catalyst matrix comprises one or more latent catalysts chosen from phenyl hydrogen maleate, phenyl trifluoroacetate and butadiene sulfone.

Aspect 36 is a resin composition of any of Aspects 33-35, wherein the catalyst matrix comprises one or more catalyst chosen from acid catalysts, basic catalysts, and peroxide catalysts.

Aspect 37 is a resin composition of any of Aspects 33-36, wherein the catalyst matrix comprises one or more of sulfuric acid, sulfonic acids, oxalic acid, boron trifluoride, boric anhydride, boric acid, and mixtures of boric acid or boric anhydride with epoxies.

Aspect 38 is a resin composition of any of Aspects 33-37, wherein the catalyst matrix comprises phenolsulfonic acid as a sulfonic acid.

Aspect 39 is a resin composition of any of Aspects 33-38, wherein the catalyst matrix comprises one or more of organic amines, and oxides and hydroxides of metals.

Aspect 40 is a resin composition of any of Aspects 33-39, wherein the catalyst matrix comprises one or more organic amine chosen from hexamethylenetetramine, trimethylamine, and ethanolamines.

Aspect 41 is a resin composition of any of Aspects 33-40, wherein the catalyst matrix comprises one or more oxides and hydroxides of metals wherein the metals are chosen from barium, calcium, sodium and potassium.

Aspect 42 is a resin composition of any of Aspects 28-41, wherein the catalyst matrix comprises an accelerator to speed up cure rate of the resin composition.

Aspect 43 is a resin composition of any of Aspects 28-42, wherein the catalyst matrix comprises zinc or cobalt salts.

Aspect 44 is a resin composition of Aspects 28-43 comprised of about 50 to 90 weight percent of the thermosetting resin, from about 0.2 to 10 weight percent of the catalyst matrix, from about 15 to 50 weight percent of the reinforcement materials, and from about 0.5 to 30 weight percent of the expandable microcapsules based on total weight of the resin composition.

Aspect 45 is a forming die wherein the interior of the die comprises a graded change in volume such that the volume of the interior of the die changes from a first section of the die to a second section of the die.

Aspect 46 is a forming die of Aspect 45, wherein the volume of the die increases from a first section of the die to a second section of the die.

Aspect 47 is a forming die of Aspect 45, wherein the volume of the die decreases from a first section of the die to a second section of the die.

Aspect 48 is a forming die of either of Aspects 45 or 46 comprising a housing, an inlet disposed at a proximal end of the housing, a shaping cavity in communication with the inlet and terminating at a distal end of the housing, an outlet disposed at the distal end of the housing and in communication with the shaping cavity, wherein the shaping cavity is configured to provide for a first smaller cross-sectional area at the proximal end of the housing and a second larger cross-sectional area at the distal end of the housing.

Aspect 49 is a forming die of Aspect 48, wherein the inlet and the outlet each have an opening with an area and the area of the opening of the inlet is 20-45% of the area of the opening of the outlet, such as 25-40%, such as 30-35%, or about 33%.

Aspect 50 is a forming die of any of Aspects 45-49, wherein a housing of the forming die has an inlet that is a U-shaped inlet and an outlet that is square or rectangular.

Aspect 51 is a forming die of any of Aspects 45-50, wherein the forming die has a shaping cavity comprising a wall that is sloped between a first smaller cross-sectional area and a second larger cross-sectional area, or that is sloped between a first larger cross-sectional area and a second smaller cross-sectional area.

### BRIEF DESCRIPTION OF THE DRAWINGS

FIG. 1 is a flowchart describing a system for performing a pultrusion process for manufacturing a composite structural article according to the invention.

FIG. 2 is a flowchart describing a system for performing an extrusion process for manufacturing a composite structural article according to the invention.

FIG. 3 is a schematic diagram depicting a system for performing a pultrusion process for manufacturing a composite structural article according to the invention.

FIG. 4 is a schematic diagram depicting a perspective view of an embodiment of a specially adjusted die that may be used in a process to manufacture a composite structural article according to the invention.

FIG. 5 is a schematic diagram depicting a perspective view of an embodiment of a specially adjusted die that may be used in a process to manufacture a composite structural article according to the invention.

FIG. 6 is a schematic diagram depicting a perspective view of an embodiment of an inventive die that may be used in a process to manufacture a composite structural article according to the invention, including an internal illustration of the forming cavity of the die.

FIG. 7 is a schematic diagram depicting a perspective view of an embodiment of an inventive die that may be used in a process to manufacture a composite structural article according to the invention, including an internal illustration of the forming cavity of the die.

FIG. 8A is a schematic diagram depicting a cross-sectional view of the inventive die with a shell of the inventive composite structural article disposed therein, with the cross section taken along the corresponding point indicated in FIG. 7.

FIG. 8B is a schematic diagram of a cross-sectional view of the inventive die with a shell and partially formed core of the inventive composite structural article disposed therein, with the cross section taken along the corresponding point shown in FIG. 7.

FIG. 8C is a schematic diagram of a cross-sectional view of the inventive die with a shell and partially formed core of the inventive composite structural article disposed therein, with the cross section taken along the corresponding point shown in FIG. 7.

FIG. 8D is a schematic diagram of a cross-sectional view of the inventive die with a shell and core of the inventive composite structural article disposed therein, with the cross section taken along the corresponding point shown in FIG. 7.

FIG. 9 is a schematic diagram depicting a view of a cross-section of an embodiment of a composite structural article according to the invention.

FIG. 10 is a schematic diagram depicting a view of a cross-section of an embodiment of a composite structural article according to the invention.

FIG. 11 is a schematic diagram depicting a view of a cross-section of an embodiment of a composite structural article according to the invention.

### DETAILED DESCRIPTION OF VARIOUS EMBODIMENTS OF THE INVENTION

Reference will now be made in detail to various exemplary embodiments of the invention. However, the embodiments described in the description and shown in the figures are illustrative only and are not intended to limit the scope of the invention, and changes may be made in the specific embodiments described in this specification and accompanying drawings that a person of ordinary skill in the art will recognize are within the scope and spirit of the invention. The claims include representative embodiments as well.

In one embodiment, a composite structure is created using pultrusion of an FRP shell and a lower-density, reinforced thermoset core resin. For example, an FRP shell is created by pulling reinforcements into a resin impregnation bath. Those resin saturated reinforcements are formed into an open-shaped three-sided shell. (Open-shaped is a term of art that means a shape whereby at least one of the shape's segments, sides, or edges is not connected to anything at one of its endpoints, such that the shape is not a closed figure.) The shell is pulled into a curing die and the core resin composition is introduced into the cavity of the shell. The core resin expands to take the shape of the cavity and fill the cavity up to or near the upper edge of the open-shaped shell, thereby forming a rectangular, elongated structure suitable for using as a railroad tie. As heat is applied to the die, the fiber-reinforced polymer shell and the core resin harden. Similarly, if a tubular shell is preferred, core resin may be introduced at an opening in the front or back end of the tube as the tube is being pultruded into the die. Alternatively, the shell can be wrapped around the core resin as the shell and core resin are pultruded through the die. In yet another embodiment, the core resin could be extruded, or pushed, into the tubular structure as the tubular structure is being pulled into the die.

In one preferred embodiment, the FRP shell and the core resin are cured at the same time. During this preferred process, a portion of the FRP shell will bleed into the core resin where the core resin meets the FRP shell. As the FRP shell and the core resin harden together as they are heated, this intermingling of the FRP shell resin and the core resin creates a fusion of the FRP shell resin and the core resin around the areas where the FRP shell resin and the core resin meet and interact, thereby strengthening the bond of the FRP shell resin to the core resin. This process occurs in a continuous pultrusion process. Continuous bears the meaning one of ordinary skill in the art would give to such a term as used in the context of a pultrusion or extrusion, which is effectively that the process is performed in a sequence.

In a similar manner, this process can be performed by an extrusion method. In a preferred method, a molten resin would be pushed through a die, thereby forming a three-sided shell structure. The resulting structure would be cooled and the core resin would be deposited into the cavity of the three-sided structure. The core resin would be heated as the composite structure of the shell and core pass through a die. In another preferred method, the core resin composition without any shell could be extruded (or pultruded) through a die and cured to form a structure suitable to use as, for example, a railroad tie.

A preferred shape of the interior of the die used to make the structural article includes a gradient whereby the volume of the interior of the die is increased in a graded manner from a point when the core resin is injected into the cavity to a point where the FRP shell and core resin exit the die. Consequently, when the core resin is inserted into the core of the FRP shell, the die allows it to expand over time until it fills the FRP shell. The core resin preferably moves through the die at a rate that allows for the resin to expand to fill the cavity. Such a die and the corresponding process will result in a varying cross section of the structural article (e.g., railroad tie) over time. Thus, in embodiments, a cross section of the structure viewed at one time during formation will not be identical to a cross section viewed at another time during formation. This is unique in that a pultruded product, for example, is historically made with a continuous cross section that will look identical or substantially identical regardless of when a cross section of the structure during formation is viewed over time, unlike a preferred embodiment of the present invention where the cross section will not be identical when viewed at different times during the formation process.

In a preferred embodiment of the product resulting from the described manufacturing process, a structure is formed, which may act as a railroad tie, the core of which structure comprises the following ingredients: thermosetting resin, catalyst matrix, reinforcement materials, and expandable microcapsules. The shell of such a preferred embodiment is preferably a U-shaped or three-sided FRP structure with a density equal to or greater than the core. Such a shell is preferably an open-shaped structure whereby one side of the elongated structure in the axial direction is open, and whereby the ends of the elongated structure are open, but the ends may be capped.

In embodiments, especially for railroad tie embodiments, the finished structure is approximately 9 inches wide and about 7 inches tall and can be any length, such as about 2 feet, 3 feet, 4 feet, 5 feet, 6 feet, 7 feet, 8 feet, 9 feet, 10 feet, 11 feet, 12 feet, 13 feet, 14 feet, 15 feet, 16 feet, 17 feet, 18 feet, 19 feet, or 20 feet and so on. A preferred length is one for which the structure can be used as a railroad tie. The structure can be any width and any height. Some exemplary widths include from about 1 inch to about 60 inches, such as from about 1 inch to about 2 inches, from about 2 inches to about 3 inches, from about 3 inches to about 4 inches, from about 4 inches to about 5 inches, from about 5 inches to about 6 inches, from about 6 inches to about 7 inches, from about 7 inches to about 8 inches, from about 8 inches to about 9 inches, from about 9 inches to about 10 inches and so on. Likewise, the structure can be any height and exemplary heights can include from about 1 inch to about 24 inches, by way of example only. Indeed, any combination of thickness, width or length can be used for the claimed structures, especially one or more of the parameters specified in this specification.

In embodiments, the finished structure weighs approximately 10% to 75% less than a standard railroad tie made of wood, such as about 10% to 20% less, about 20% to 30% less, about 30% to 40% less, about 40% to 50% less, about 50% to 60% less, about 60% to 70% less, or about 70% to 75% less. In embodiments, the finished structure may last 4-5 times longer than a standard wood railroad tie, by way of example.

Suitable thermosetting resins for use as the FRP shell include polyester resin, vinyl ester resin, epoxy resin, phenolic resin, and urethane resin. In a preferred embodiment, the resin is an isophthalic polyester or a vinyl ester resin. During pultrusion, for example, the resin may be provided in a mixture that includes one or more catalysts and/or accelerators. Catalysts that may be included in the resin mixture include latent catalysts that have little or no catalytic activity below a certain temperature, above which the catalyst is active. Examples of latent catalysts include phenyl hydrogen maleate, phenyl trifluoroacetate and butadiene sulfone. Other types of catalysts that may be used include acid catalysts, basic catalysts, and peroxide catalysts. Typical acid catalysts are sulfuric acid, sulfonic acids such as phenolsulfonic acid, oxalic acid, boron trifluoride, boric anhydride, boric acid and mixtures of boric acid or boric anhydride with epoxies. Typical basic catalysts include organic amines such as hexamethylenetetramine, trimethylamine, ethanolamines and oxides and hydroxides of metals such as barium, calcium, sodium and potassium. An accelerator may be included to speed up the cure rate of the resin. Typical accelerators are zinc or cobalt salts.

Suitable reinforcement materials for use as the FRP shell include fiberglass, fiberglass-based material, wood-based materials, or recycled fiber-reinforced polymer. Other reinforcement materials suitable for the shell include carbon, hemp, glass, steel, twine, or anything generally that can be put into tension.

Particular examples of possible ingredients for a suitable catalyst mixture for the FRP shell include Perkadox® 16 (a di(4-tert-butylcyclohexyl) peroxydicarbonate) (www.akzonobel.com/polymer/our_products/perkadox_16-40ps/), Trigonox® 121-C75 (a tert-Amylperoxy-2-ethylhexanoate) (www.akzonobel.com/fc/brands_products/product_search/product_finder_detail.aspx?id=12426), Tringonox® EHPTS (a Di(2-ethylexyl) peroxydicarbonate, stabilized) (akzonobel.com/polymer), Trigonox® 121-BB75 (a tert-Amyl-peroxy-2-ethylhexanoate), and Trigonox® C (a tert-Butyl peroxybenzoate).

Particular examples of suitable resin for the FRP shell include resin supplied by Ashland® Performance, such as Polyester 2036 Modified, and as supplied by AOC Solutions®, such as P706-500. Particular examples of mats and rovings to reinforce the FRP shell include MatVantage® II (a continuous filament mat without binder) and various rovings supplied by PPG®, as well as M8643 and equivalents (continuous filament mats with binders) and various rovings supplied by Owens Corning®. Some recycled mat and rovings may also be used in the core resin composition. A particular example of filler includes ASP400P supplied by Superior Materials, Inc. A particular example of a veil to, for example, provide a surface protectant from UV light and corrosive environments, includes the veil supplied by Xamax®. A particular example of Styrene which may be used in the FRP shell is supplied by Chemsolv. A particular example of a release which may be used in the FRP shell includes SR150 supplied by Technick Products. A particular example of additives BHT which may be used in the FRP shell to inhibit the catalyst and thereby prevent premature curing in the resin bath is supplied by Composites One®. Particular examples of fire retardants which may be used in the shell include bromine, antimony, and ATH (alumina trihydrate), such as those supplied by Azalea Color/Omya Distribution.

A preferred density value for the shell is around 0.07 lbs/in³. The density value for the shell may be about 0.01 lbs/in³ to 5 lbs/in³, such as about 0.01 lbs/in³ to 0.05 lbs/in³, about 0.05 lbs/in³ to 0.1 lbs/in³, about 0.1 lbs/in³ to 0.15 lbs/in³, about 0.15 lbs/in³ to 0.20 lbs/in³, about 0.2 lbs/in³ to 0.25 lbs/in³, about 0.25 lbs/in³ to 0.3 lbs/in³, about 0.3 lbs/in³ to 0.35 lbs/in³, about 0.35 lbs/in³ to 0.4 lbs/in³, about 0.4 lbs/in³ to 0.45 lbs/in³, about 0.45 lbs/in³ to 0.5 lbs/in³, and so on. A preferred tensile strength for the shell is around 2.5×10⁶ psi. The tensile strength of the shell may be about 0.5×10⁶ psi to 5.0×10⁶ psi, such as about 0.5×10⁶ psi to 1×10⁶ psi, about 1×10⁶ psi to 1.5×10⁶ psi, about 1.5×10⁶ psi to 2×10⁶ psi, about 2×10⁶ psi to 2.5×10⁶ psi, about 2.5×10⁶ psi to 3×10⁶ psi, and so on.

Suitable thermosetting resins for use as the matrix of the core resin composite include polyester resin, vinyl ester resin, epoxy resin, phenolic resin, and urethane resin. In a preferred embodiment, the resin is an isophthalic polyester or a vinyl ester resin. During pultrusion, the resin may be provided in a mixture that includes one or more catalysts and/or accelerators. Catalysts that may be included in the resin mixture include latent catalysts that have little or no catalytic activity below a certain temperature, above which the catalyst is active. Examples of latent catalysts include phenyl hydrogen maleate, phenyl trifluoroacetate and butadiene sulfone. Other types of catalysts that may be used include acid catalysts, basic catalysts, and peroxide catalysts. Typical acid catalysts are sulfuric acid, sulfonic acids such as phenolsulfonic acid, oxalic acid, boron trifluoride, boric anhydride, boric acid and mixtures of boric acid or boric anhydride with epoxies. Typical basic catalysts include organic amines such as hexamethylenetetramine, trimethylamine, ethanolamines and oxides and hydroxides of metals such as barium, calcium, sodium and potassium. An accelerator may be included to speed up the cure rate of the resin. Typical accelerators are zinc or cobalt salts.

Particular examples of suitable resin for the core resin include resin supplied by Ashland® Performance, such as Polyester 2036 Modified, and as supplied by AOC Solutions®, such as P706-500. Preferable boiling points for resin in the core resin include boiling points between 100 and 400 degrees Fahrenheit, such as about 100 degrees ° F. to 120 degrees ° F., about 120 degrees ° F. to 140 degrees ° F., about 140 degrees ° F. to 160 degrees ° F., about 160 degrees ° F. to 180 degrees ° F., about 180 degrees ° F. to 200 degrees ° F., about 200 degrees ° F. to 220 degrees ° F., about 220 degrees ° F. to 240 degrees ° F., about 240 degrees ° F. to 260 degrees ° F., about 260 degrees ° F. to 280 degrees ° F., about 280 degrees ° F. to 300 degrees ° F., about 300 degrees ° F. to 320 degrees ° F., about 320 degrees ° F. to 340 degrees ° F., about 340 degrees ° F. to 360 degrees ° F., about 360 degrees ° F. to 380 degrees ° F., or about 380 degrees ° F. to 400 degrees ° F. The viscosity of the resins which may be used in the core resin composition may, for example, be from 1,000 to 20,000 centipose (cps), such as about 1,000 cps to 2,000 cps, about 2,000 cps to 3,000 cps, about 3,000 cps to 4,000 cps, about 4,000 cps to 5,000 cps, about 5,000 cps to 6,000 cps, about 6,000 cps to 7,000 cps, about 7,000 cps to 8,000 cps, about 8,000 cps to 9,000 cps, and so on.

Particular examples of possible ingredients for a suitable catalyst mixture for the core resin include Perkadox® 16 (a di(4-tert-butylcyclohexyl) peroxydicarbonate) (www.akzonobel.com/polymer/our_products/perkadox_16-40ps/), Trigonox® 121-C75 (a tert-Amyl peroxy-2-ethylhexanoate) (www.akzonobel.com/fc/brands_products/product_search/product_finder_detail.aspx?id=12426), Tringonox® EHPTS (a Di(2-ethylexyl) peroxydicarbonate, stabilized) (akzonobel.com/polymer), Trigonox® 121-BB75 (a tert-Amyl-peroxy-2-ethylhexanoate), and Trigonox® C (a tert-Butyl peroxybenzoate). A preferred embodiment of the catalyst matrix comprises around 60.55% Trigonox® 121-BB75 (a tert-Amyl-peroxy-2-ethylhexanoate), 15.6% Trigonox® C (a tert-Butyl peroxybenzoate), and 23.85% Perkadox® 16 (a di(4-tert-butylcyclohexyl) peroxydicarbonate).

Suitable reinforcement materials for use in the core resin mixture include fiberglass, fiberglass-based material, wood-based materials, or recycled fiber-reinforced polymer. Other reinforcement materials suitable for the core resin mixture include carbon, hemp, glass, steel, twine, or anything generally that can be put into tension. A preferred embodiment includes glass rovings and glass mat reinforcement materials in the shell, and milled fibers (e.g., ground-up glass), recycled fiber-reinforced polymer, and ground-up wood reinforcements in the core.

The core resin also includes microcapsules, such as a PMMA/acrylic microcapsules. Expandable microcapsules are used to reduce the weight of products based on thermoplastics and elastomers. Preferably, the microcapsules are thermally expandable, such as thermoplastic hollow microspheres. (Microcapsules are interchangeably referred to as microspheres by those of skill in the art.) The microcapsules as disclosed herein are hollow bodies of plastic (e.g., a copolymer, such as vinylidene chloride, acrylonitrile or methyl methacrylate) encapsulating a substance that is capable of expanding when exposed to heat (such as isobutene or isopentane). Such microcapsules are not known to be in use in any other pultrusion process application. For example, the expandable microcapsules supplied by Kureha®, H-1100 and M-330, are suitable acrylic microcapsules for the core resin mixture. The Expancel® 461DET lines of microcapsules, products of Expancel® Nobel Industries, may also be used. These thermally expandable microcapsules comprise a polymer shell encapsulating a gas blowing agent (for example, aliphatic hydrocarbons). When heated, the gas in the shell expands increasing pressure while the thermoplastic shell softens, resulting in expansion. Upon cooling a hollow and extremely light plastic sphere remains.

Microcapsules with the trade name Expancel® 092 DE may also be used. Examples of other suitable materials may include, but are not limited to, Expancel® DU, Expancel® MB, Expancel® DE, Expancel® 551DE, Expancel® 091DU, Expancel® 461DU, or the product names “Matsumoto Microsphere F-85,” “Matsumoto Microsphere F-100,” “Microsphere FE,” etc. from Matsumoto Yushi-Seiyaku of Japan, the Advancell line from Sekisui Chemical Company, Ltd., or other blowing agent microcapsules may be used without departing from the scope of the present invention.

These microcapsules can expand by a factor of at least 2, preferably 4 in diameter, resulting in a volume expansion of each particle of 64 or more. It is preferred that the microcapsules expand at the temperatures used to cure the core resin. Microcapsules may be obtained in a range of densities and it is preferred to use expandable microspheres having a density in the range of 15 Kg/m³ to 85 Kg/m³, such as about 15 Kg/m³ to 20 Kg/m³, about 20 Kg/m³ to 25 Kg/m³, about 25 Kg/m³ to 30 Kg/m³, about 30 Kg/m³ to 35 Kg/m³, about 35 Kg/m³ to 40 Kg/m³, about 40 Kg/m³ to 45 Kg/m³, about 45 Kg/m³ to 50 Kg/m³, about 50 Kg/m³ to 55 Kg/m³, about 55 Kg/m³ to 60 Kg/m³, about 60 Kg/m³ to 65 Kg/m³, about 65 Kg/m³ to 70 Kg/m³, about 70 Kg/m³ to 75 Kg/m³, about 75 Kg/m³ to 80 Kg/m³, or about 80 Kg/m³ to 85 Kg/m³. Expansion temperatures range from 80° C. to 190° C., such as about 80° C. to 90° C., about 90° C. to 100° C., about 100° C. to 120° C., about 120° C. to 140° C., about 140° C. to 160° C., about 160° C. to 180° C., or about 180° C. to 190° C. The particle size for expanded microcapsules ranges from 20-150 μm, such as about 20 μm to 30 μm, about 30 μm to 40 μm, about 40 μm to 50 μm, about 50 μm to 60 μm, about 60 μm to 70 μm, about 70 μm to 80 μm, about 80 μm to 90 μm, about 90 μm to 100 μm, about 100 μm to 110 μm, about 110 μm to 120 μm, about 120 μm to 130 μm, about 130 μm to 140 μm, or about 140 μm to 150 μm. When fully expanded, the volume of the microcapsules can increase more than 40 times. Detailed descriptions of various expandable microcapsules and their production can be found in, for example, U.S. Pat. Nos. 3,615,972, 3,945,956, 4,287,308, 5,536,756, 6,235,800, 6,235,394, 6,509,384, 6,617,363 and 6,984,347.

A particular example of styrene which may be used in the core composition is supplied by Chemsolv. A particular example of a release which may be used in the core composition includes SR150 supplied by Technick Products. A particular example of additives BHT which may be used in the core composition to inhibit the catalyst and thereby prevent premature curing is supplied by Composites One®.

An example of a preferred core mixture composition comprises about 50 to 90 weight percent total of thermosetting resin, such as about 50 to 60 weight percent total of thermosetting resin, about 60 to 70 weight percent total of thermosetting resin, about 70 to 80 weight percent total of thermosetting resin, or about 80 to 90 weight percent total of thermosetting resin. An example of a preferred core mixture composition comprises from about 0.2 to 10 weight percent total of catalyst matrix, such as about 0.2 to 1 weight percent total of catalyst matrix, about 1 to 2 weight percent total of catalyst matrix, about 2 to 3 weight percent total of catalyst matrix, about 3 to 4 weight percent total of catalyst matrix, about 4 to 5 weight percent total of catalyst matrix, about 5 to 6 weight percent total of catalyst matrix, about 6 to 7 weight percent total of catalyst matrix, about 7 to 8 weight percent total of catalyst matrix, about 8 to 9 weight percent total of catalyst matrix, or about 9 to 10 weight percent total of catalyst matrix. An example of a preferred core mixture composition comprises from about 15 to 50 weight percent total of reinforcement material, such as about 15 to 20 weight percent total of reinforcement material, about 20 to 25 weight percent total of reinforcement material, about 25 to 30 weight percent total of reinforcement material, about 30 to 35 weight percent total of reinforcement material, about 35 to 40 weight percent total of reinforcement material, about 40 to 45 weight percent total of reinforcement material, or about 45 to 50 weight percent total of reinforcement material. An example of a preferred core mixture composition comprises from about 0.5 to 30 weight percent total of microcapsules, such as about 0.5 to 5 weight percent total of microcapsules, about 5 to 10 weight percent total of microcapsules, about 10 to 15 weight percent total of microcapsules, about 15 to 20 weight percent total of microcapsules, about 20 to 25 weight percent total of microcapsules, or about 25 to 30 weight percent total of microcapsules.

In a preferred embodiment, the core resin composition comprises around 73 weight percent total of thermosetting resin, around 0.33 weight percent total of catalyst matrix, around 24 weight percent total of reinforcement material, and around 2 weight percent total of microcapsules. In another preferred embodiment, the core resin composition comprises around 72.85 weight percent total of thermosetting resin, around 0.417 weight percent total of catalyst matrix, around 28.62 weight percent total of reinforcement material, and around 2.43 weight percent total of microcapsules. In another preferred embodiment, the core resin composition comprises around 68.68 weight percent total of thermosetting resin, around 0.442 weight percent total of catalyst matrix, around 24.28 weight percent total of reinforcement material, and around 2.29 weight percent total of microcapsules.

The density of the core composition is surprisingly dense given its weight. An exemplary specimen might measure 14.8596 cubic inches and weigh 0.3210 lbs. This results in a density of 0.02160 lbs./in³. Converted to lbs./ft³, which is the unit used in, for example, Table 1 of prior art patent U.S. Pat. No. 8,342,420 (col. 6, l. 35), the density is 37.3248 lbs./ft³. By way of example, Table 1 in U.S. Pat. No. 8,342,420 teaches structures with a density ranging from 1 to 5 lbs./ft³. Therefore, the currently disclosed core composition may be approximately 7.5 times more dense than the core compositions disclosed by U.S. Pat. No. 8,342,420, yet weigh approximately the same as those taught by U.S. Pat. No. 8,342,420 (see column 5, ll. 62-65). One example of a core density to weight ratio of the currently disclosed structural articles includes a core density of 0.025 lbs./in³ and final weight of a 9″×7″×102″ railroad tie of 186 lbs. Another example of a core density to weight ratio of the currently disclosed structural articles includes a core density of 0.019 lbs./in³ and final weight of a 9″×7″×102″ railroad tie of 151 lbs. The density of the core resin could, for example, be about 0.005 lbs./in³ to 5 lbs./in³, such as about 0.005 lbs./in³ to 0.01 lbs./in³, about 0.01 lbs./in³ to 0.02 lbs./in³, about 0.02 lbs./in³ to 0.03 lbs./in³, about 0.03 lbs./in³ to 0.04 lbs./in³, about 0.04 lbs./in³ to 0.05 lbs./in³, about 0.05 lbs./in³ to 0.06 lbs./in³, about 0.06 lbs./in³ to 0.07 lbs./in³, about 0.07 lbs./in³ to 0.08 lbs./in³, and so on.

The viscosity of the core resin composition may, for example, be from 1,000 to 20,000 centipose (cps), such as about 1,000 cps to 2,000 cps, about 2,000 cps to 3,000 cps, about 3,000 cps to 4,000 cps, about 4,000 cps to 5,000 cps, about 5,000 cps to 6,000 cps, about 6,000 cps to 7,000 cps, about 7,000 cps to 8,000 cps, about 8,000 cps to 9,000 cps, and so on.

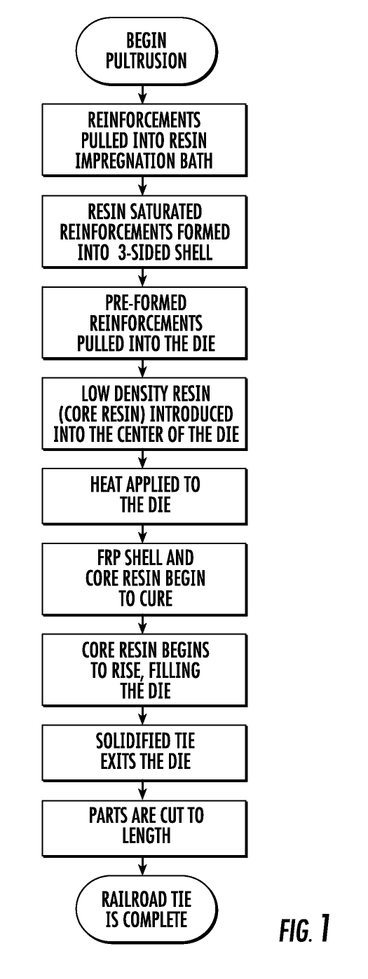

Now turning to the figures, FIG. 1 generally depicts a pultrusion method starting with reinforcement material being pulled into a resin impregnation bath. Various alternative techniques which are well known in the art can be used to apply or impregnate the fibers with thermosetting resin. Such techniques include, but are not limited to, spraying, dipping, roll coating, brushing, and the like. Preimpregnated fibers can also be used. Other techniques which are known to impregnate fibers include pressure assisted impregnation which is also referred to as resin injection. The resin reinforced impregnated fibers are then formed into a three-sided shell, such as by using a forming guide system, also known as “preformer” by one of skill in the art, which can, for example, comprise one or a plurality of machined plates, sheet metal guides, or the like, which forms the resin impregnated fibers into the approximate shape of the desired shell. The resulting pre-formed reinforced shell is pulled into the die, and lower density core resin is introduced into the open cavity of the three-sided shell. As heat is applied to the die, the thermoexpandable core resin begins to expand, while the shell simultaneously beings to cure. As the core expands and heat is applied to the die as the shell and core are pultruded through the die, the shell and the core resin solidify to create the desired pultruded article. In embodiments where the shell is disposed with the elongated opening upward, the resin material of the core will rise to the upper limit of the graded surface of the interior of the forming die. As the resin material of the core rises and as the shell and core travel through the die, the core will reach a maximum height, which corresponds to the height of the graded surface at the distal end of the die. The shell and core continue to pass through the die and the resultant material, a composite block, solidifies and travels toward the housing exit at the distal end of the die. The resulting material is cut to a desired size, such as the size of a railroad tie, and the process is complete.

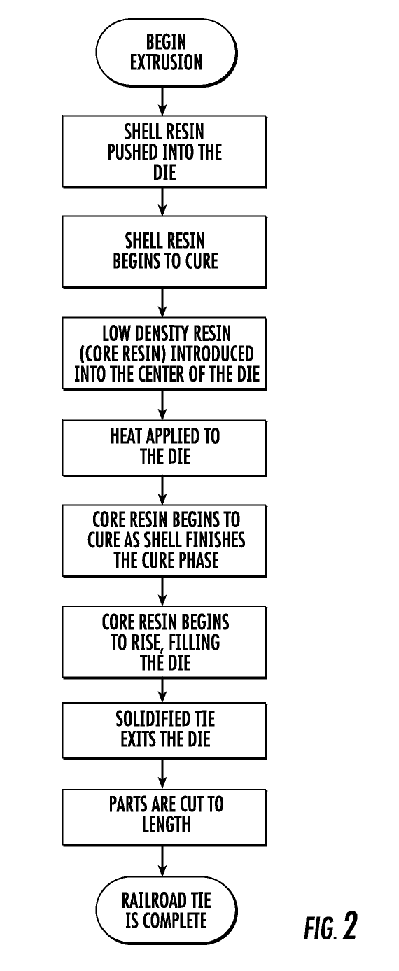

Alternatively, the structural article of the present invention may be made using an extrusion process. FIG. 2 generally depicts an extrusion method starting with the pre-formed shell being pushed into an extrusion die. As the resin of the shell begins to cure due to heat applied by the die, a lower density core resin is introduced into the open cavity of the pre-formed shell. As heat is applied to the die, the shell approaches completion of the curing process while the core resin begins to cure and rise. As heat is continually applied to the die, the core resin fills the cavity of the shell and both the shell and core harden to form the desired structural article. The article is cut to the desired length and the railroad tie is complete.

Referring to FIG. 3, a pultrusion apparatus is generally designated by numeral 300. The apparatus includes a plurality of creels or spools 310 from which reinforcement material is supplied, otherwise called a “roving” creel. Additional reinforcement material is supplied by way of the so-called “mat” rack 320, before the reinforcement material enters the resin impregnation bath 330. Before entering the die 350, the impregnated resin is pre-formed into a three-sided shell 340 by means of a series of material forming/shaping plates.

The resulting pre-formed reinforced shell is pulled into the die 350, and lower density core resin is introduced into the open cavity of the three-sided shell (designated by the arrows at die 350 in FIG. 3). As heat is applied to the die, the thermoexpandable core resin begins to expand, while the shell simultaneously begins to cure. As the core rises and heat is applied to the die as the shell and core are pultruded through the die, the shell and the core resin solidify to create the desired pultruded article. A pultruding mechanism is identified by 360, which could be, for example either a Caterpillar® design in which two opposing tracks rotate to create forward motion, or a reciprocating puller in which (usually) two sets of gripping pads engage the profile and separate and pull the profile forward. The first gripping pad advances the profile while the second sits idle. Once the full travel of the first gripper is reached, the second gripper begins to advance, and the cycle repeats itself. Finally, the article is cut to size by a saw 370, such as a large circular blade or a band saw. Both the blade or saw could include some type of abrasive finish, typically some grade of diamonds.

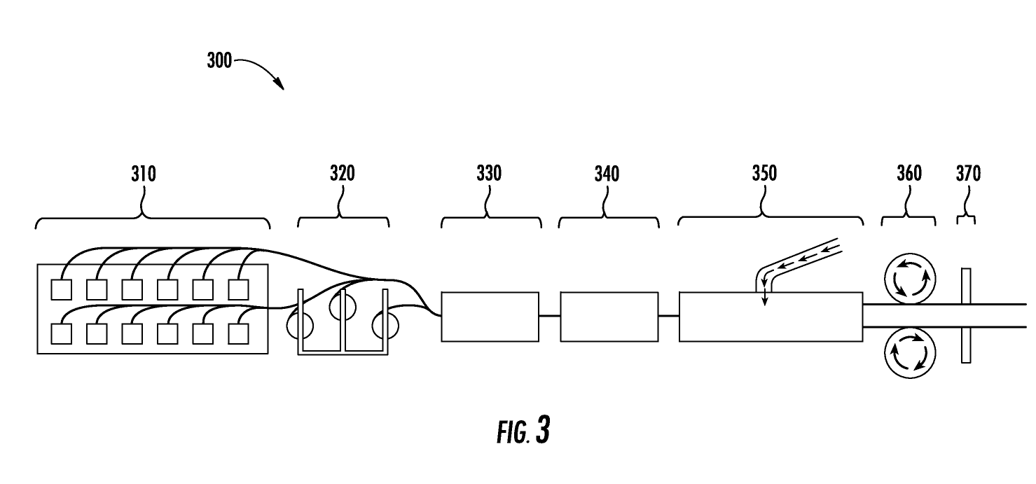

FIG. 4 generally depicts a pultrusion die 450 that could be used to cure the FRP shell and the core resin. An opening 452 allows for the pre-formed shell to enter into the die. Preferably, the opening is a U-shaped opening to facilitate the entrance of a pre-formed shell in a U-shape, with an open cavity to receive the core resin composition. As the shell is pulled into the die, the core resin is introduced by, for example, a tube or other means of injection 451 into the center of the U-shaped shell. As the shell and core are heated, the shell begins to cure and the thermoexpandable core resin begins to rise, filling the open cavity of the shell. As the shell and core resin pass through the die they are continually heated until they are hardened and exit the die at preferably a rectangular opening 453, which is the shape of a preferred embodiment of the structural article claimed by the present invention. The opening of the die is not required to be U-shaped. The shell, for example, does not necessarily need to be U-shaped. For example, the shell might have no side walls, it could only have one planar surface on which the core resin is applied. The core resin could be disposed on top of this planar material so that the final product has only a one-sided shell.

FIG. 5 similarly depicts a pultrusion die 550 that could be used to cure the FRP shell and core resin. This figure depicts the side of the die opposite the side depicted in FIG. 4. Similar to the description of FIG. 4, an opening 552 allows the pre-formed shell into the die. Preferably, the opening is a U-shaped opening to facilitate the entrance of a pre-formed shell in a U-shape, with an open cavity to receive the core resin composition. As the shell is pulled into the die, the core resin is introduced by, for example, a tube or other means of injection 551 into the center of the U-shaped shell. As the shell and core are heated, the shell begins to cure and the thermoexpandable core resin begins to rise, filling the open cavity of the shell. As the shell and core resin pass through the die they are continually heated until they are hardened and exit the die at preferably a rectangular opening 553, which is the shape of a preferred embodiment of the structural article claimed by the present invention.

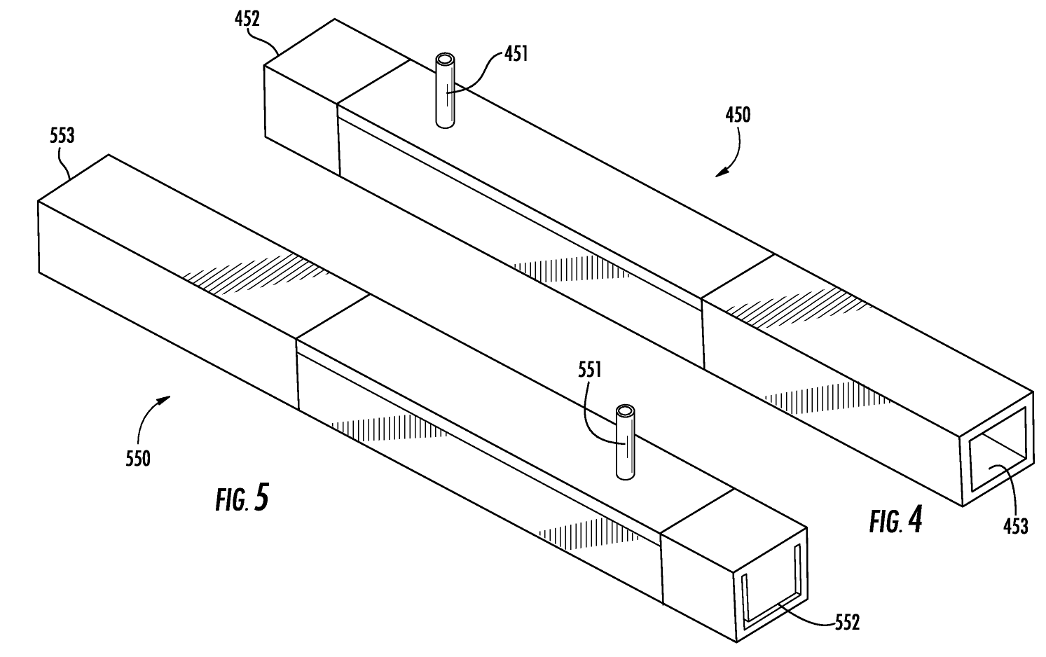

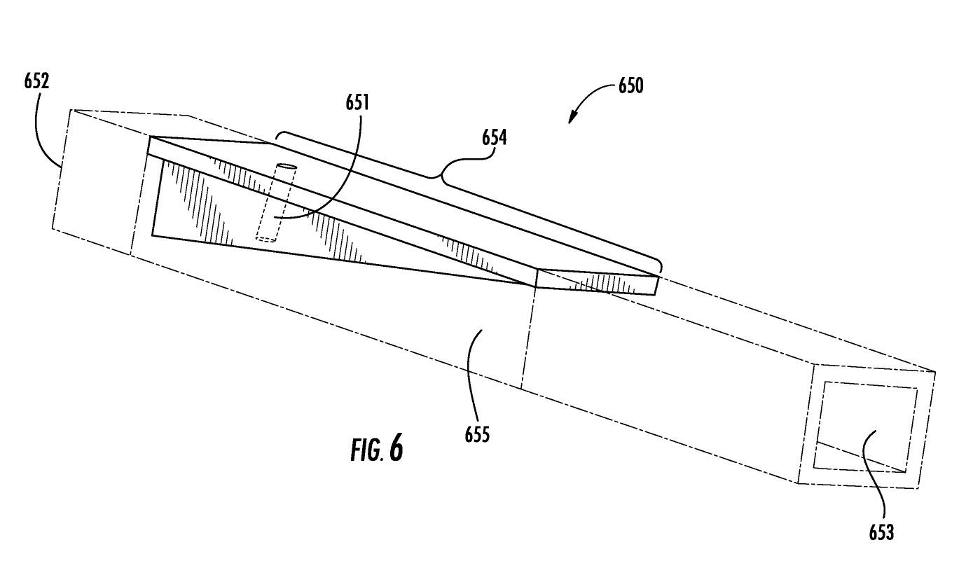

FIG. 6 depicts a pultrusion die 650 similar to the dies depicted in FIGS. 4-5, but with the interior cavity of the die viewable, including the interior portion of the die 654 that allows the volume of the interior to increase as the thermoexpandable core resin is heated and rises. Interior portion of the die 654 may also be referred to as the die ceiling. A preferred embodiment of the invention is a die with a housing, an inlet disposed at a proximal end of the housing, a shaping cavity in communication with the inlet and terminating at a distal end of the housing, and an outlet disposed at the distal end of the housing and in communication with the shaping cavity, wherein the shaping cavity is configured to provide for a first smaller cross-sectional area at the proximal end of the housing and a second larger cross-sectional area at the distal end of the housing. The shell enters the die in preferably a U-shaped opening 652. The core resin is injected or otherwise introduced 651 into the cavity of the shell. As the core resin is heated and expands, its rise is controlled within the die's open cavity 655, by a preferably graded increase 654 in the interior's volume as the core resin and shell are pulled through the die. This graded increase is preferably sloped relative to a bottom surface of the interior of the forming die at an angle of about 5-95%, such as from about 20-75%, or from about 25-60%, or from about 30-45%, or from 35-50%, or from about 33-40%. The rate of pulling should be commensurate with allowing the core to form to a desired shape or density.

Conventional pultrusion dies can be provided with a cavity for heat expanding resin, but are not provided with such a cavity wherein an internal sloping apparatus is used to increase the volume of the cavity over the entire length of the cavity, or a portion of the length of the cavity, so that the expanding resin rises in a controlled manner and can be done in a continuous fashion. Preferably, the end result is a rectangular shaped structure that is light but dense and can be used as a railroad tie. Accordingly, the exit of the die is preferably a rectangular shape 653.

FIG. 7 similarly depicts a pultrusion die 750 that may be used to form the claimed structural article. Similar to FIG. 6, a preferably U-shaped pre-formed shell enters the die in a U-shaped opening 752. As the shell begins to cure by heat applied to the die, core resin is introduced into the cavity of the shell by injection or any other appropriate means 751. As heat is applied to the die, the thermoexpandable core resin begins to rise within the graded interior cavity 755 of the die. The die ceiling allows the core resin to rise in a gradual, controlled manner through the means of an interior that is allowed to increase in volume over time as the shell and core are being pulled through the die and pressing against the die ceiling 754. During pultrusion, the resin material of the core conforms to the interior shape of the 3-sided shell with the fourth side of the core being limited in height by the upper interior surface of the die. As the core reaches the top of the U-shaped shell, both are continually cured until they form a solid structural article that may be used as a railroad tie. The structural article exits the die as a rectangular structure 753 and is cut to a desired size.

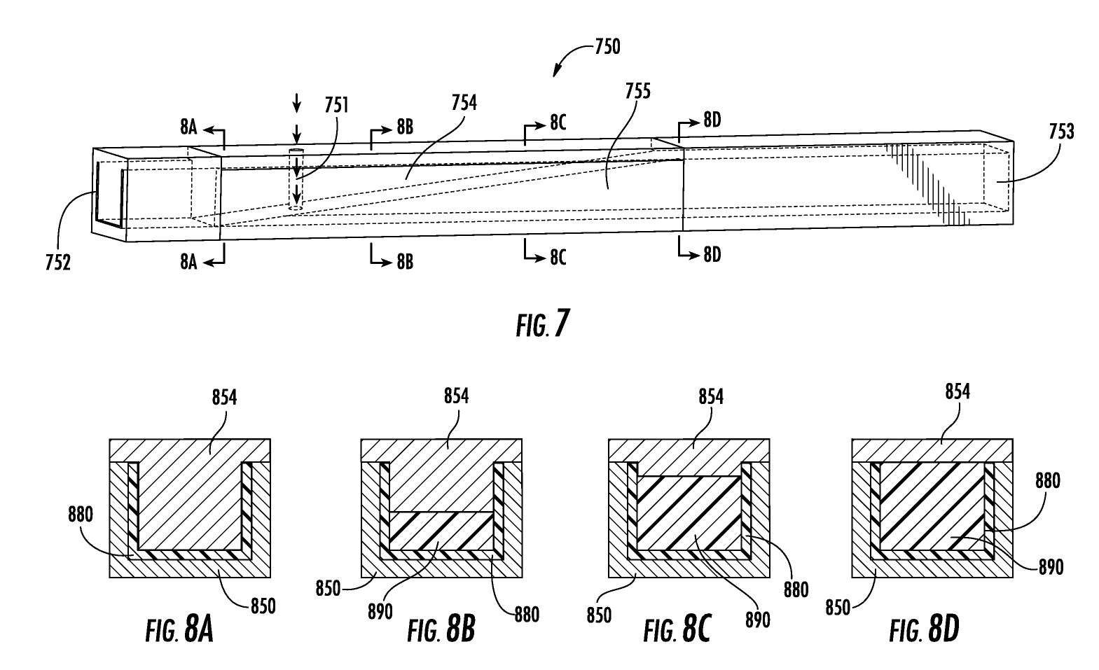

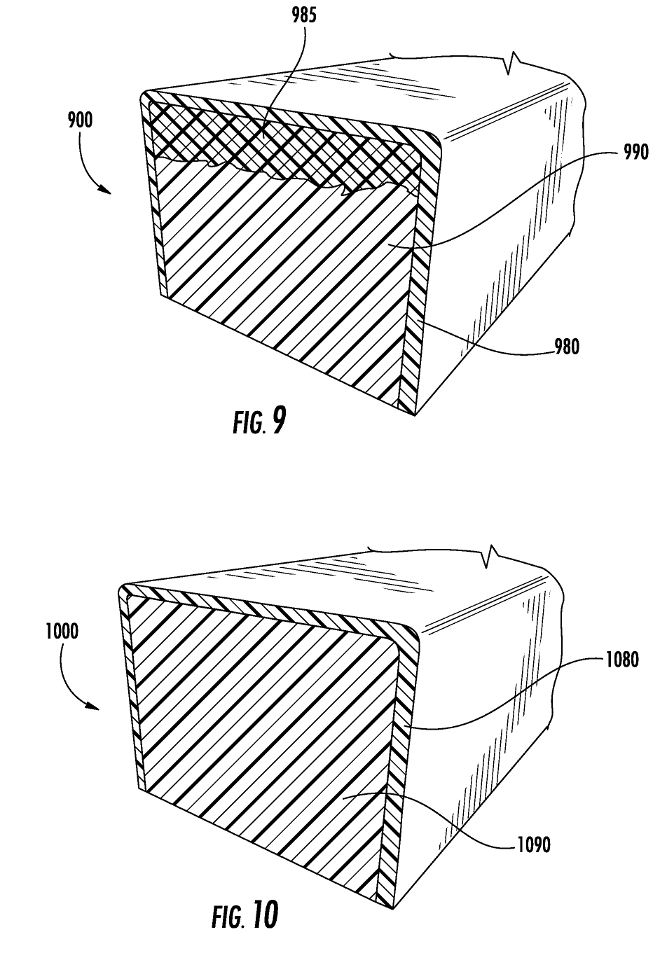

FIG. 8 provides a cross-sectional view transverse to the machine direction of portions of the die and the structural article as it passes through the die. When viewed in conjunction with FIG. 7, it is shown that the cross-sections vary over time depending on when they are viewed as the shell and core resin pass through the die during the pultrusion process. FIG. 8A depicts a cross-section of the shell entering the die before core resin is added to the shell. The shell 880 passes through a U-shaped opening wherein the die 850 starts to cure the shell. The die maintains the shell in its U-shaped shape by way of ceiling 854, as the shell starts to cure and prior to introduction of the core resin. Downstream in the process, depicted by FIG. 8B, the cavity of the shell 880 is disposed in the die with the elongated cavity or channel facing toward ceiling 854 to allow for introduction of the thermoexpandable core resin 890. The die 850 continues to heat and cure both the shell and resin continuously and the core is being allowed to rise in a controlled fashion due to the upward sloping interior of the die ceiling 854. FIG. 8C shows a cross section of the article within the die, wherein the core resin 890 has almost expanded to the point where it fills the elongated channel or cavity of the shell 880. The slope of the die ceiling 854 in FIG. 8C is at a point in the process close to where the core completely fills the cavity of the shell. In FIG. 8D, the core resin 890 has filled the cavity of the shell 880 and has been shaped by the die ceiling to create a preferred rectangular structure. The shell and core continue to be heated and cured simultaneously and continuously until they exit the die as the claimed structural article which can be used as, for example, a railroad tie.

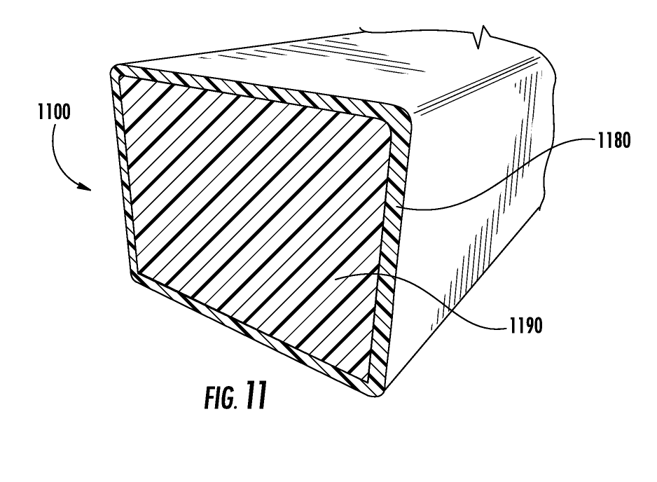

FIGS. 9, 10, and 11 show embodiments of the structural article according to the present invention. FIG. 9 depicts an embodiment whereby the shell 980 and core resin 990 have fused 985 due to the continuous pultrusion process and simultaneous curing of both the shell and resin. Fused or fusion herein means a partial, complete or total fusion of the shell and core resin. Alternatively, FIG. 10 depicts an embodiment whereby the shell 1080 and core 1090 have not undergone fusion during the curing process. FIG. 11 depicts an embodiment whereby the shell 1180 is a tubular structure encircling the core resin 1190.

### EXAMPLES

### Example 1

Railroad ties of the present invention that are of significant value are those capable of passing one or more of the “American Railway Engineering and Maintenance-of-Way Association Manual for Railway Engineering” specifications (“AREMA specifications”) for Engineered Polymer Composites. (See, e.g., AREMA specifications at pp. 30-5-4 to 30-5-7 (Table 30-5-1. Physical and Mechanical Properties) (2013).)

For example, railroad ties of the present invention are preferred to meet one or more of the following physical and mechanical properties:

a. The tie shall permit the application of standard rail, tie plate, and hold-down fasteners, such as screw spikes or cut spikes, without requiring special procedures for installation other than ordinary predrilling of the tie per the manufacturer's requirements.

b. The tie shall provide an adequate flexural response to absorb train induced vibrations, while possessing sufficient vertical compressibility to withstand rail seat loading. Tie must support imposed railroad-type loadings while maintaining surface, line, and gage. Tie must transmit traffic loads to the ballast with diminished contact pressures and anchor the rail-tie structure against lateral and longitudinal movements.

c. Material surfaces shall have slip resistance equal to or better than a standard treated wood tie.

d. The tie shall not be prone to failure (e.g., cracking or fracture) due to weather-related changes in temperature.

e. The tie shall not warp or sag to the level of permanent deformation that would require replacement of the tie.

f. The tie shall not split or crack in any way requiring the tie to be replaced.

g. Material surface degradation due to solar ultraviolet (UV) radiation exposure shall not exceed 0.003 inch (0.076 mm) per year.

### Example 2

The railroad ties of the present invention are preferred to meet one or more of the dimensional requirements according to the AREMA specifications; specifically:

a. All measurements performed for quality assurance purposes shall be made at 73.4+/−2° F. (23+/−1.1° C.) and relative humidity of 50+/−5%. Alternatively, measurements may be made at ambient temperature and humidity conditions and then corrected to the specified temperature and humidity. In case of dispute, the standard conditions shall govern.

b. For a standard gage track tie, the rail-bearing areas are those sections between 20 inches (510 mm) and 40 inches (1020 mm) from the center of the tie. Tie surface flatness in the area of the tie plate shall be within 0.125 inch (3.18 mm).

c. Tie dimensions as specified shall be full size. All ties, without surface texturing, shall have a thickness tolerance+¼ inch (6.4 mm), −0 inch (0 mm); width tolerance+/−¼ inch (6.4 mm); length tolerance+¾ inch (19 mm), −0 inch (0 mm). Ties with surface texturing shall meet nominal specified dimensions as required for the application.

d. Standard ties, 7 inch (178 mm) by 9 inch (229 mm) by 8.5 to 9 foot (2.6 m to 2.7 m) long, without surface texturing, will be considered straight when a straight line along each tie face from the middle of one end to the middle of the other end is no closer to the edge of the tie than one-half the tie face dimension, plus ¼ inch (6.4 mm) or minus ¼ inch (6.4 mm). For ties surface textured for increased track stability, this tolerance shall be a maximum plus ¾ inch (19 mm) or minus ¾ inch (19 mm).

### Example 3

The railroad ties of the present invention are preferred to meet one or more Physical and Mechanical Properties according to the AREMA specifications in Table 30-5-1; specifically:

| | | Polymer |
|---|---|---|
| | Test Method | Composites |
| Modulus of Elasticity | Part 2, | Minimum, 170,000 |
| (in bending - center | Section 2.2.3, | (1,170) |
| negative) - MOE, psi | Test 1C | |
| (MPa) | | |
| Modulus of Rupture | Part 2, | Minimum, |
| (in bending - center | Section 2.2.3, | 2,000 |
| negative) - MOR, psi | Test 1C | (13.8) |
| (MPa) | | |
| Rail Seat | Part 2, Section 2.3, | Minimum, |
| Compression, psi | Test 2 | 900 |
| (MPa) | | (6.2) |
| Single Tie Lateral | Part 2, Section 2.9, | Minimum, |
| Push, lbf (kN), after | Test 8 | 2,500 |
| 100,000 gross tons of | | (11.1) |
| Traffic | | |
| Spike/Screw Pullout, | Part 2, | Minimum, |
| lbf (kN) | Section 2.4.1, | 1,900/5,000 |
| | Test 3A | (8.5/22.2) |
| Coefficient of | ASTM D6431 | Maximum, |
| Thermal Expansion, | | 7.5 × 10−5 |
| in/in/° F. (cm/cm/° C.) | | (1.35 × 10⁻⁴) |
| Electrical Impedance, | Part 2, Section 2.8, | Minimum, |
| Ohms | Test 7 | 20,000 |

### Example 4

The railroad ties of the present invention are preferred to meet one or more Mechanical Properties according to the AREMA specifications in Table 30-A-1; specifically:

| Dimensions (in.): | |
|---|---|
| Length | 102 |
| Width | 9 |
| Depth | 7 |
| Volume (ft²) | 3.72 |
| Density, pcf (lbs/ft²) | 50-86 |
| Weight (lbs) | 186-320 |
| Moment of Inertia (in⁴) | |
| Seat | 257 |
| Center | 257 |
| Section Modulus (in³) | |
| RS+ | |
| RS− | |
| C− | 73.5 |
| C+ | |
| Modulus of Elasticity (MOE) (10⁶ psi) | |
| −40 F. | |
| +72 F. | |
| 140 F. | 0.17 |
| Modulus of Rupture (MOR) (psi) | |
| −40 F. | |
| +72 F. | 2,000 |
| 140 F. | |
| Rail Seat Compression Test (psi) | 900 |
| Material Surface Hardness Test Janka Ball | 5,000 |
| (lbs) | |
| Single Tie Lateral Push Test (lbs) | 1,500-4,000+ |

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Embodiments comprising various features may also consist of or consist essentially of those various features. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention. All references cited in this specification are hereby incorporated by reference in their entireties.

1. A method of manufacturing a composite structural form, the method comprising:
providing a shell comprising a first resin composition;
disposing a second resin composition with a different composition than the first resin composition in a cavity of the shell to provide a core; and
passing the shell and the core through a die to prepare a composite structural form.

2. The method of claim 1, wherein the first resin composition and the second resin composition are pultruded through a die to prepare a composite structural form.

3. The method of claim 1, wherein the first resin composition and the second resin composition are extruded through a die to prepare a composite structural form.

4. The method of claim 1, wherein the first resin composition and the second resin composition are continuously passed through a die to prepare a composite structural form.

5. The method of claim 1, wherein the cavity is defined by an elongated channel in the shell.

6. The method of claim 1, wherein the shell is disposed in the die with the elongated channel oriented in a direction capable of receiving the second resin during the passing of the shell through the die.

7. The method of claim 1, wherein the shell is three-sided and provides an elongated opening in the shell.

8. The method of claim 1, wherein the shell comprises a tubular shape.

9. The method of claim 1, wherein the second resin composition is allowed to fuse with the first resin composition as the first and second resin compositions are subjected to conditions capable of curing the first and second resin compositions.

10. The method of claim 1, wherein the first resin composition and the second resin composition are subjected to conditions capable of curing the first and second resin compositions.

11. A composite structure comprising:
a shell comprising a first resin composition; and
a core having a second resin composition comprising:
thermosetting resin;
a catalyst matrix;
reinforcement material; and
expandable microcapsules.

12. The composite structure of claim 11, wherein the shell provides an elongated channel in the shell.

13. The composite structure of claim 11, wherein the shell is three-sided and provides an elongated channel in the shell.

14. The composite structure of claim 11, wherein the shell comprises a tubular shape.

15. The composite structure of claim 11, wherein the article is a railroad tie.

16. The composite structure of claim 11, wherein the shell comprises a base and two side walls and the two side walls are parallel to one another.

17. The composite structure of claim 11, wherein the shell comprises a base and only two side walls, wherein the two side walls are parallel to one another and wherein each side wall is disposed perpendicular to the base.

18. A resin composition comprising:
a) thermosetting resin;
b) a catalyst matrix;
c) reinforcement material; and
d) expandable microcapsules.

19. The resin composition of claim 18, wherein the expandable microcapsules are thermally expandable microcapsules comprising a polymer shell encapsulating a gas blowing agent.

20. The resin composition of claim 18 comprised of about 50 to 90 weight percent of the thermosetting resin, from about 0.2 to 10 weight percent of the catalyst matrix, from about 15 to 50 weight percent of the reinforcement material, and from about 0.5 to 30 weight percent of the expandable microcapsules based on total weight of the resin composition.

21. The resin composition of claim 18, which is cured and is in the shape of a railroad tie.

22. An article of manufacture comprising a forming die with an interior having a graded change in volume such that the volume of the interior changes from a first section of the die to a second section of the die.

23. A forming die comprising:
a housing;
an inlet disposed at a proximal end of the housing;
a shaping cavity in communication with the inlet and terminating at a distal end of the housing;
an outlet disposed at the distal end of the housing and in communication with the shaping cavity;
wherein the shaping cavity is configured to provide for a first smaller cross-sectional area at the proximal end of the housing and a second larger cross-sectional area at the distal end of the housing.

24. The forming die of claim 23, wherein the inlet and the outlet each have an opening with an area and the area of the opening of the inlet is 20-45% of the area of the opening of the outlet.

25. The forming die of claim 23, wherein the inlet is a U-shaped inlet and the outlet is square or rectangular.

26. The forming die of claim 23, wherein the shaping cavity is defined by a die floor and a die ceiling and the die ceiling is sloped upwardly relative to the die floor at an angle ranging from 20-50% between the first smaller cross-sectional area and the second larger cross-sectional area.
